(19) United States
(12) Patent Application Publication
(10) Pub. No.: US 2022/0122029 A1
(43) Pub. Date: Apr. 21, 2022

(54) PICK ASSIST SYSTEM

(71) Applicant: Rehrig Pacific Company, Los Angeles, CA (US)

(72) Inventors: Robert Lee Martin, JR., Lucas, TX (US); Peter Douglas Jackson, Alpharetta, GA (US); Steven Stavro, Santa Monica, CA (US)

(21) Appl. No.: 17/448,441

(22) Filed: Sep. 22, 2021

Related U.S. Application Data
(60) Provisional application No. 63/142,267, filed on Jan. 27, 2021.
(60) Provisional application No. 63/081,802, filed on Sep. 22, 2020.

(51) Int. Cl. G06Q 10/08; B62B 3/06; B62B 5/00; G06K 7/10; G06V 10/40

(52) U.S. Cl. CPC G06Q 10/087; B62B 3/0612; B62B 2203/20; G06K 7/10366; G06V 10/40; B62B 5/0096

(57) ABSTRACT

A pick assist system helps to ensure that each pallet is built accurately. Further, the pick assist system may also help to ensure that the products on each pallet are arranged in a way so that the loaded pallet will be stable and will be efficient to unload. A pallet sled includes a base and a pair of tines extending from the base. The pallet sled further includes a display. At least one processor is programmed to provide a series of instructions on the display indicating a plurality of products to be placed on at least one pallet supported by the tines.

### BACKGROUND

The delivery of products to stores from distribution centers has many steps that have the potential for errors and inefficiencies. When the order from the store is received, at least one pallet is loaded with the specified products according to a “pick list” indicating a quantity of each product to be delivered to the store.

For example, the products may be cases of beverage containers (e.g. cartons of cans, beverage crates containing bottles or cans, cardboard trays with plastic overwrap containing cans or bottles, etc). There are numerous permutations of flavors, sizes, and types of beverage containers delivered to each store. When building pallets, missing or mis-picked product can account for significant additional operating costs.

### SUMMARY

A pick assist system disclosed herein helps to ensure that each pallet is built accurately. Further, the pick assist system may also help to ensure that the products on each pallet are arranged in a way so that the loaded pallet will be stable and will be efficient to unload.

A pallet sled includes a base and a pair of tines extending from the base. The pallet sled further includes a display. At least one processor is programmed to provide a series of instructions on the display indicating a plurality of products to be placed on at least one pallet supported by the tines.

The at least one processor may be programmed to cause the display to display a color image of each of the products to be placed on the at least one pallet.

The at least one processor may be programmed to cause the display to display a map indicating a location of a next product to be retrieved and a quantity of the next product to be retrieved.

The pallet sled may further include a camera configured to image a product being retrieved by a user. The at least one processor may be programmed to analyze the image to determine if the product being retrieved by the user is the next product to be retrieved.

The at least one processor may be programmed to cause the display to display a rejection screen based upon the at least one processor determining that the product being retrieved by the user is not the next product to be retrieved.

The pallet sled of claim 1 wherein the at least one processor is programmed to cause the display to display a desired location for the user to place a next product of the plurality of products relative to the at least one pallet supported by the tines.

The at least one processor may be programmed to generate a 3D image of the at least one pallet supported by the tines and a plurality of products already placed on the at least one pallet. The 3D image includes an indication of where the next product should be placed. The at least one processor may be programmed to cause the display to display the 3D image to assist the user in placing the next product in the right location on the pallets.

The pallet sled may include a camera configured to image the plurality of products on the at least one pallet supported by the tines. The at least one processor may be programmed to analyze the image to determine whether at least one of the plurality of products is in a correct location.

The at least one processor is programmed to cause the display to display a rejection based upon the at least one processor determining that at least one of the plurality of products is in an incorrection location.

The pallet sled may be an automated guided vehicle.

The display and the at least one processor may be provided in the form of a tablet or smartphone.

The tablet or smartphone may be rotatably mounted relative to the base such that the display can selectively face forward or rearward of the pallet sled. In this manner, the user can see the display when guiding or riding on the pallet sled or when loading products on the tines of the pallet.

The at least one processor is programmed to associate an rfid tag of each of the at least one pallet with each of at least one pick sheet containing a list of SKUs associated with an order.

The pallet sled may further include an rfid reader configured to read the rfid tag on each of the at least one pallet supported by the tines.

The pick assist system may include a pallet destacker. The pallet destacker may include a column for retaining at least one stack of pallets. An rfid reader is configured to read rfid tags on the pallets. A processor is programmed to determine pallet ids based upon the rfid tags. A communication circuit is configured to transmit the pallet ids. For example, the pallet ids may be transmitted to the pallet sled and/or to a remote CPU (e.g. server, cloud computer, etc).

A method for picking a pallet includes the step of displaying on a display a pallet sled a next product image of a next product to be retrieved. A location on the pallet sled where to place the next product to be retrieved is then displayed on the display.

The display may further display the location relative to at least one pallet and optionally relative to two pallets on the pallet sled.

A method for assisting picking a pallet includes imaging a product as it is being brought toward the pallet. The image of the product is analyzed to determine if it is the next product to be retrieved. It is then indicated to the picker whether the product is the next product to be retrieved.

The result of the analysis may be transmitted to a validation station to assist with later validation of the pallet.

### BRIEF DESCRIPTION OF THE DRAWINGS

FIG. 1 shows a first example of a pick system.

FIG. 2 is a front perspective view of the pallet sled and pallets of FIG. 1.

FIG. 3 shows the mobile device of FIG. 1 displaying a generated 3D image of the desired fully-loaded pallet.

FIG. 4 shows the pallet sled of FIG. 1 capturing an image of the picker.

FIG. 5 shows the pallet sled of FIG. 1 in the distribution center.

FIG. 6 shows the pallet sled of FIG. 1 with the mobile device displaying an image of the next product to be picked and the associated quantity on the rear-facing screen.

FIG. 7 shows the pallet sled of FIG. 1 with the mobile device indicating that the picker is carrying a product that is not the desired next product.

FIG. 8 shows the pallet sled of FIG. 1 with the mobile device indicating the location to place the next product.

FIG. 9 shows the mobile device of FIG. 8 showing a 3D representation of the partially-loaded pallets and an indication of the location to place the next product.

FIG. 10 shows the pallet sled of FIG. 1 with the mobile device indicating that the product has been placed in the correct location on the pallets and on the stack of products.

FIG. 11 shows the pallet sled of FIG. 1 with the mobile device indicating that the product has been placed in an incorrect location on the pallets and on the stack of products.

FIG. 12 shows the pallet sled of FIG. 1 with the mobile device instructing the picker which validation station to take the pallets.

FIG. 13 shows another example pallet sled incorporated as an automated guided vehicle that could be used in the pick system of FIG. 1.

FIG. 14 shows two of the pallet sleds of FIG. 13.

FIG. 15 shows the pallet sled of FIG. 13 approaching a pallet destacker.

FIG. 16 shows the pallet sled and pallet destacker of FIG. 15, with the pallet sled retrieving two empty pallets from the pallet destacker.

FIG. 17 shows the pallet sled of FIG. 13 in a first arrangement in a distribution center.

FIG. 18 shows the pallet sled of FIG. 13 in a second arrangement in a distribution center.

FIG. 19 shows the pallet sled of FIG. 13 bringing two loaded pallets to a validation station.

FIG. 20 shows a pallet on a turntable of a validation station.

FIG. 21 illustrates a variation of the pallet sled including smart glasses.

FIG. 22 shows the glasses of FIG. 21 confirming the selection of the next product and indicating a location to place the next product.

FIG. 23 is another view of the user wearing the glasses of FIG. 22 and placing the next product onto the pallets.

FIG. 24 shows a frame and mobile device of an alternate pallet sled that could be used in the pick system of FIG. 1.

### DETAILED DESCRIPTION

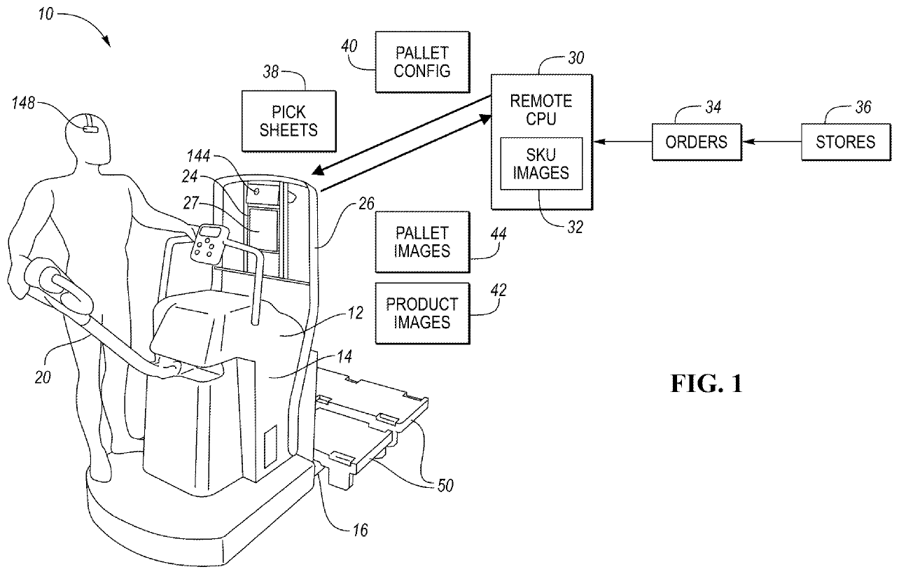

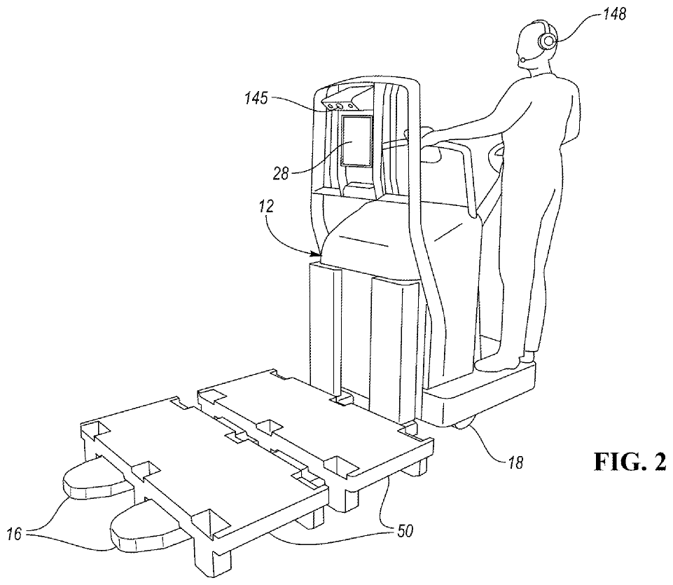

FIG. 1 shows one possible implementation of a pick system 10 including a pallet sled 12 having a base 14 and pair of tines 16 that are selectively raised and lowered relative to the base 14. Wheels 18 (FIG. 2) support the base 14 and tines 16 and may propel the pallet sled 12. A handle 20 is pivotably connected to the base 14 for controlling the pallet sled 12. The pallet sled 12 may use a standard pallet jack mechanism for raising the tines 16 relative to the floor, or any type of electrical, hydraulic or mechanical lift system.

As is known, the tines 16 are selectively raised and lowered relative to the floor to lift pallets 50 and transport them with the pallet sled 12. In the examples shown herein, two half-pallets 50 are carried on the tines 16, but full-size pallets could also be used. For example, the pallet sleds may carry a single full-size pallet instead of two half-pallets 50, but otherwise would operate the same. If two half-pallets 50 are carried by the pallet sled 12, they are both picked at the same time.

A mobile device 24, such as a tablet or smartphone (e.g. iPad or iPhone), is mounted to a frame 26 extending upward from the base 14. The mobile device 24 may be a commercially-available tablet or smartphone having at least one processor, electronic storage (for storing data and instructions), a first touchscreen 27 facing the user, at least one rear-facing camera 144, and multiple wireless communication modules (such as wi-fi, Bluetooth, cell data, NFC, etc). The mobile device 24 may also include circuitry (internally or as an external accessory) and programming for determining its location within the distribution center (e.g. relative to fiducials throughout the distribution center).

The pick system 10 includes a remote CPU 30, such as a server, cloud computer, cluster of computers, etc. The remote CPU 30 could be multiple computers performing different functions at different locations. The remote CPU 30, among other things, stores a plurality of images of each of a plurality of available SKUs. For example, the available SKUs in the example described herein are cases of beverage containers, such as cartons of cans, plastic beverage crates containing bottles or cans, cardboard trays with plastic overwrap containing bottles or cans, cardboard boxes of bottles or cans, etc. There are many different permutations of flavors, sizes, case types, and types of beverage containers that may each be a different SKU.

The remote CPU 30 is programmed to receive orders 34 from a plurality of stores 36. Each order 34 is a list of SKUs and a quantity of each SKU. As will be explained in more detail below, the mobile device 24 and the remote CPU 30 are programmed to communicate, including (in broad terms) the mobile device 24 receiving pick sheets 38 from the remote CPU 30. The pick sheets 38 each contain a list of SKUs that should be on the same pallet 50. Additionally, the remote CPU 30 may also send pallet configuration 40 files containing information indicating the location on each pallet 50 where each SKU should be placed, as will be explained further below. The remote CPU 30 also sends the SKU images 32 (images of what each SKU should look like, including at least one side, but preferably two or three or all sides of the SKU) to the mobile device 24.

The remote CPU 30 dictates merchandizing groups and sub groups for loading items 20 on the pallets 50 in order to make unloading easier at the store. For example, the pick sheets 38 may dictate that certain products 20 destined for one store are on one pallet 50 while other products 20 destined for the same store are on another pallet 50. The pick sheets 38 and pallet configurations 40 also specify arrangements of SKUs on each pallet 50 that group products efficiently and for a stable load on the pallet 50. For example, cooler items should be grouped, and dry items should be grouped. Splitting of package groups is also minimized to make unloading easer. This makes pallets 50 more stable too. Eventually, each pick sheet 38 is associated with a pallet id, such that each SKU is associated with a particular palled id (and a particular pallet 50). Products 20 destined for different stores would be on different pallets 50, but more than one pallet 50 may be destined for one store.

As will be further explained, the mobile device 24 may send product images 42 (i.e. images of individual products being carried by a user) and pallet images 44 (images of loaded or partially loaded pallets) to the remote CPU 30. Alternatively, these images 42, 44 are processed locally on the mobile device 24.

Referring to FIG. 2, the mobile device 24 in this example also has a second touchscreen 28 (or an external, connected second touchscreen), facing the pallets 50. A headset 148 worn by the picker may relay instructions from the mobile device 24 to the picker and may relay commands from the picker to the mobile device 24, such as via Bluetooth.

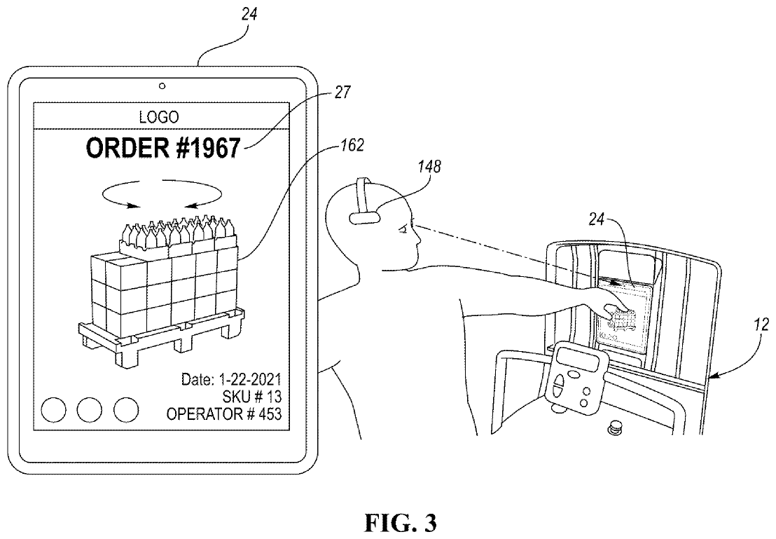

Referring to FIG. 3, the pick sheet 38, in this case for order number 1967, is sent to the mobile device 24 from the remote CPU 30 (FIG. 1). The remote CPU 30 also sends to the mobile device 24 SKU images 32 for every SKU on the pick sheet 38. This can happen along with every pick sheet 38 or the mobile device 24 can store all the SKU images 32 and periodically receive updates.

The mobile device 24 generates a 3D image 162 of what the final, loaded pallet 50 should look like, with all the products in the proper location according to the pallet configuration 40 from the remote CPU 30 and using the SKU images 32 from the remote CPU 30. The user can rotate and otherwise manipulate (e.g. removing layers) the 3D image 162 on the touchscreen 27 of the mobile device 24. The user can at any time prompt the mobile device 24 to display either final pallet 50 carried by the pallet sled 12.

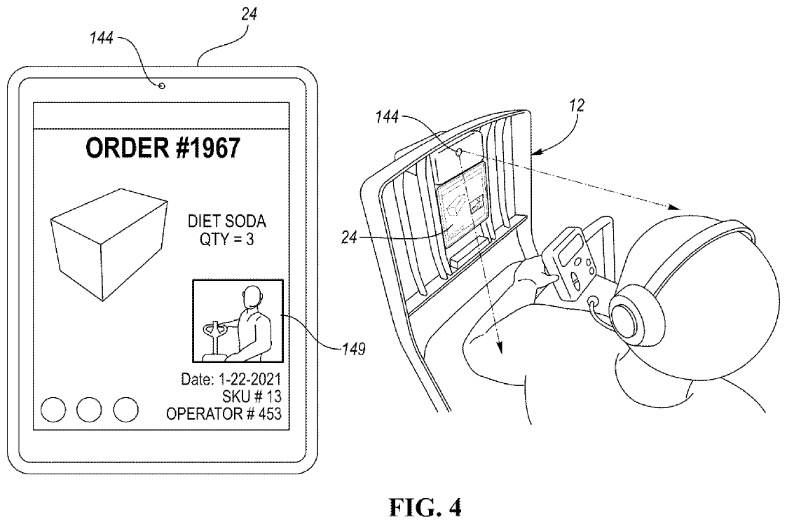

As shown in FIG. 4, a back-facing camera 144 on the mobile device 24 takes a picture 149 of the picker for accountability management for every pallet 50.

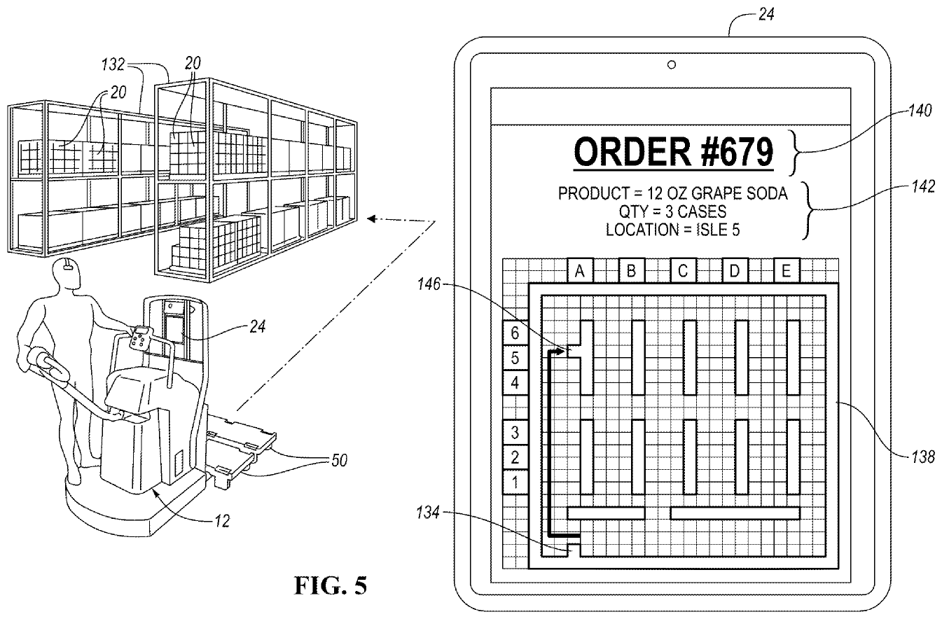

Referring to FIG. 5, the different products 20 are arranged on shelves 132 throughout the distribution center. The pick sheet 38, in this case for order number 679, is sent to the mobile device 24. The mobile device 24 displays the order number in an order number field 140. The mobile device 24 identifies the next product in a next product field 142 and displays a map 138 of the distribution center indicating the current location 134 of the pallet sled 12 and the item location 146 of the next product 20 to be loaded onto one of the pallets 50. The mobile device 24 may determine its position within the distribution center using known electronic and software methods. Alternatively, the mobile device 24 assumes that the user has guided the pallet sled 12 to the locations as directed by the mobile device 24 according to the displayed maps 138 and sequentially displays maps of how to get from one location to the next.

The remote CPU 30 (FIG. 1) has determined an exact desired arrangement of the products 20 on each pallet 50 and sends this information in the pallet configuration 40 file. The remote CPU 30a communicates the pick sheet 38 and pallet configuration 40 to the mobile device 24 along with the sequence of pick instructions. Alternatively, the mobile device 24 can determine the sequence of pick instructions based upon the pallet configuration 40 and optionally also based upon a stored map of the locations of the SKUs in the distribution center. As shown in FIG. 5, the mobile device 24 identifies the next item to be picked and the quantity in the next product field 142 and the location 146 of products 20 corresponding to that SKU on the map 138.

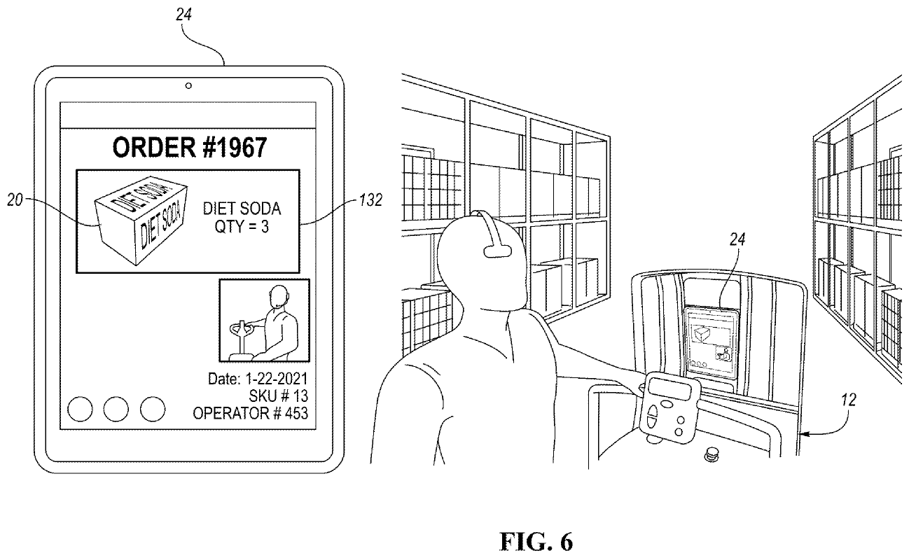

As shown in FIG. 6, the when the mobile device 24 determines that it is at the location 136 of the next product 20 (or when the user tells the mobile device 24 that it is), the mobile device 24 then displays a full color image 152 of the next product 20 to be picked (based upon SKU images 32) and the associated quantity on the rear-facing screen. This is particularly helpful when the packaging for the product 20 has changed, so the picker can find the right product 20 quickly.

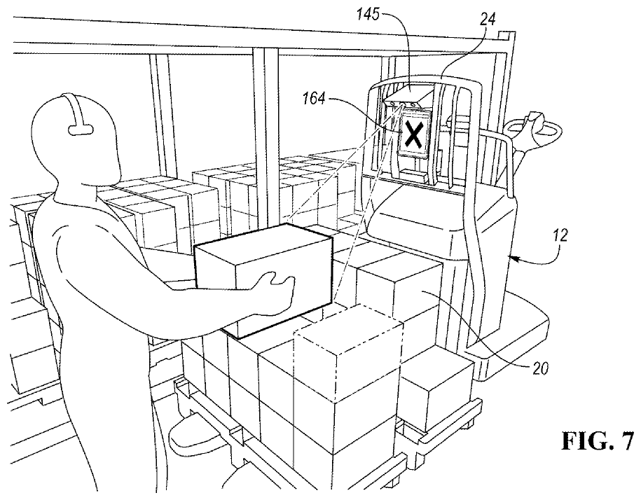

Referring to FIG. 7, using camera 145, the mobile device 24 may take images (stills or video) of each product 20 retrieved by the user as the user approaches the pallet sled 12, i.e. while the product 20 is still in the user's hands. The image may be sent to the remote CPU 30 as product image 42 (FIG. 1) or it may be processed locally by the mobile device 24. The mobile device 24 (or remote CPU 30) identifies each product 20 by SKU (such as by using a machine learning model trained on the available SKUs). The mobile device 24 checks to ensure that the identified SKU matches the SKU that the mobile device had indicated was the next product to be retrieved. If it matches, a confirmation screen is displayed. If it does not match, a rejection screen 164 is displayed on the mobile device 24 as shown in FIG. 7. The user returns the incorrect product 20 to the shelves and retrieves the correct product 20 and the mobile device 24 repeats the verification. This step is repeated for each of the required quantity of product 20 associated with the current SKU. If there are not enough products 20 associated with the current SKU in stock on the shelves, the user can so indicate this on the mobile device 24. This information is eventually passed on to the validation station.

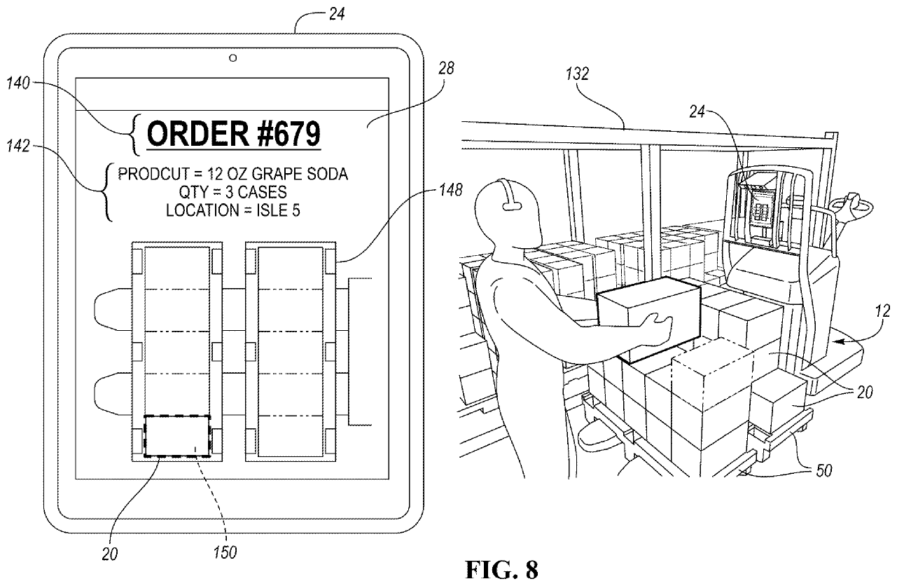

Referring to FIG. 8, if the mobile device 24 confirms that the correct product 20 has been retrieved, the mobile device 24 instructs the user exactly where on the pallets 50 to place the next product 20, including which pallet 50 and the location on that pallet 50. As shown, the front-facing touchscreen displays a loading instruction screen 148, which shows an image of the pallets 50 and tines and places an icon 150 at the location on the pallets 50 where the next product 20 should be placed. The user then places the product 20 on the pallets 50 according to the loading instruction screen 148. If more than one product 20 with this SKU is required, the mobile device 24 indicates the location for each product 20 sequentially, or alternatively, indicates all of the locations at once.

Note that both pallets 50 are being picked at the same time and each is associated with a different pick sheet 38. Therefore, the mobile device 24 may indicate that one or more products associated with a particular SKU should be placed on one pallet 50 and one or more products associated with the same SKU should be placed on the other pallet 50.

After retrieving the required number of products 20 at the first location, the mobile device 24 indicates the next location where the next product(s) 20 can be retrieved (similar to FIG. 5), and then the exact location(s) where the next product(s) 20 should be placed on the pallets 50 (similar to FIG. 8).

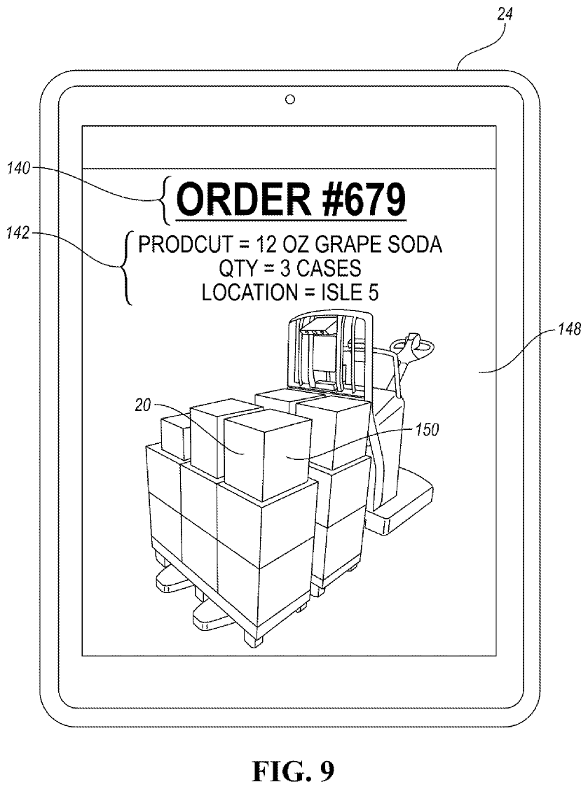

The user can choose to have the mobile device 24 build and display an updated 3D image of the pallets 50 and products 20 that have already been loaded as the loading instruction screen 148, as shown in FIG. 9. The mobile device 24 creates the 3D image from the stored SKU images 32 and the known locations of the already-loaded SKUs on the pallets 50. The mobile device 24 indicates the exact location for the next product 20 in the 3D image of the partially loaded pallets 50. Each of the previously-placed products 20 is displayed in full color on its proper location on the pallets 50. The next product 20 is displayed in its desired location relative to the previously-loaded products 20. The next product 20 is visually distinguished, such as by flashing, being outlined, being displayed translucently, being displayed in color while the loaded products 20 are displayed in greyscale (or at least reduced saturation), or other visual effect or some combination of such visual effects.

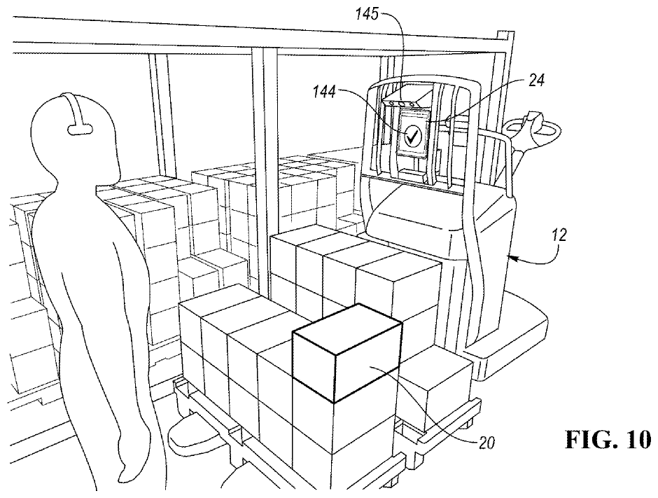

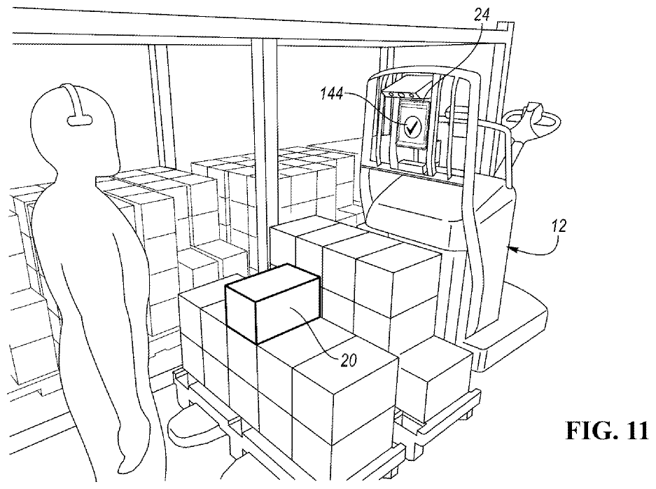

As shown in FIGS. 10 and 11, after the user places the next product 20, the mobile device 24 takes an image (or images) with camera 145 to verify that the product 20 is placed in the correct location on the pallets 50 and on the stack of products 20. This image may be sent to the remote CPU 30 as pallet image 44 it may be processed locally on the mobile device 24. Again, either confirmation (FIG. 10) or rejection (FIG. 11) is displayed. If a rejection is displayed, the mobile device 24 returns to a screen indicating the correct location (e.g. FIG. 8 or FIG. 9).

The steps of FIGS. 6 to 11 are repeated until both pallets 50 are loaded according to the pick sheets 38 and pallet configurations 40.

The confirmations, any uncorrected errors or rejections, and any missing SKUs (or insufficient quantities) are recorded and sent to the remote CPU 30 and associated with the specific pallets 50. Confirmations and uncorrected errors or rejections may be associated with specific SKUs at specific locations on the specific pallets 50. Later, at a validation station, images of the loaded pallet 50 may be taken and analyzed, such as by using a machine learning model, to verify that the SKUs on the pallet 50 match the SKUs on the pick sheet 38. Confirmations by the mobile device 24 on the pallet sled 24 can be used at validation as an input to validation, i.e. there is already a level of confidence that the correct SKUs are on the pallet 50 at the correct locations. Uncorrected problems are also passed along to the validation station so that they can be corrected there. Additionally, there may be a third state where the mobile device 24 was neither able to confirm nor reject with a high level of confidence. This is passed onto the validation station as well, along with the specific SKU(s) and location(s) on the pallets 50. The validation state will then ensure that it can confirm or reject the SKUs at the locations on the pallets 50, or flag it for manual confirmation.

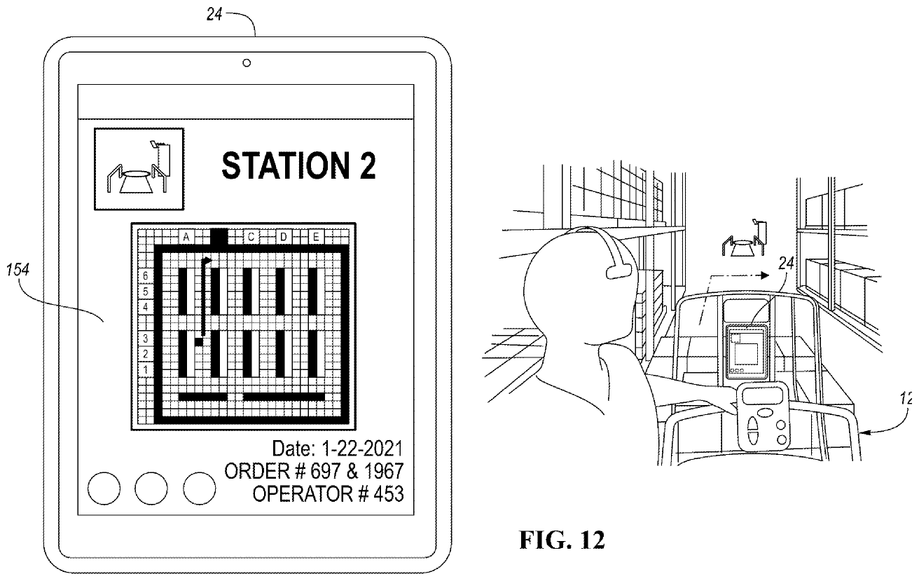

In FIG. 12, the mobile device 24 then displays a screen 154 instructing the picker which validation station to take the pallets 50. The screen 154 may display a map of the distribution center with the location of the designated validation station. This ensures efficient use of the validation stations. The confirmation/rejection/unconfirmed status information discussed above is passed along to that validation station (but would be available to any validation station from remote CPU 30).

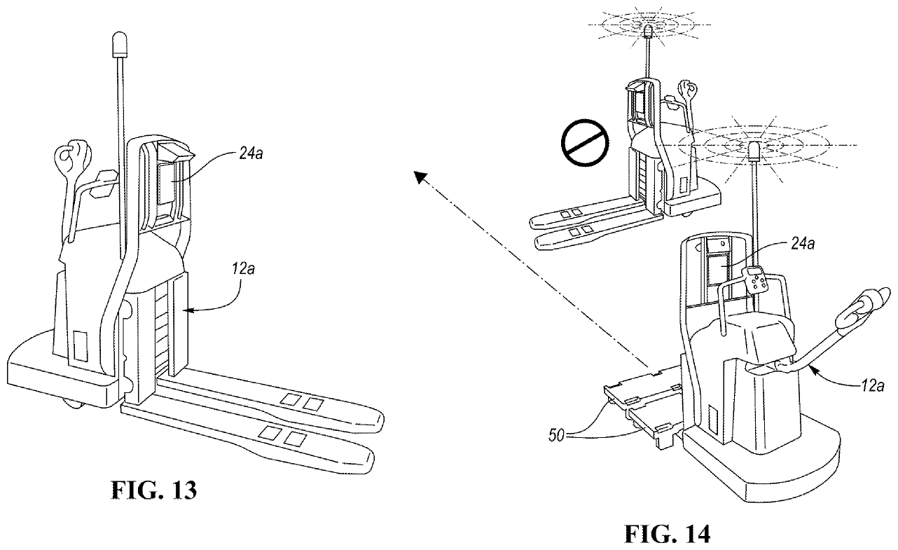

FIGS. 13 and 14 illustrate an alternative pallet sled 12a, which is identical to the pallet sled 12 but is also an automated guided vehicle. The pallet sled 12a is used in the manner described above but in addition, the pallet sled 12a automatically retrieves pallets 50 and follows a route from product to product, so that the picker or pickers can place the right products on the right pallet 50 (again, according to displayed instructions by the mobile device 24a). The picker may ride on the pallet sled 12a or there may be a different picker at each location in the distribution center.

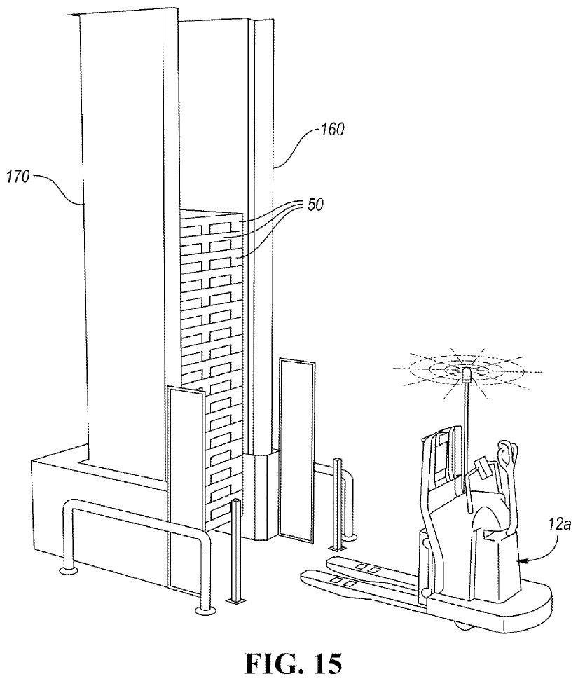

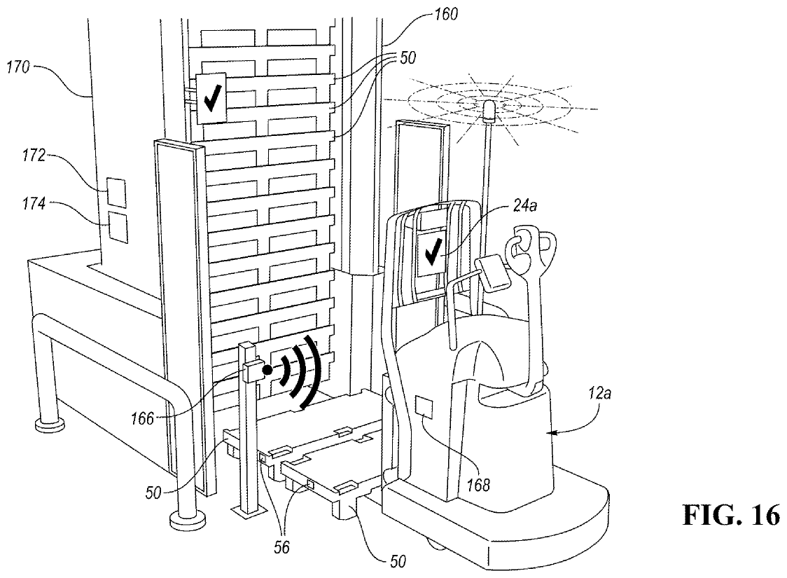

Referring to FIGS. 15 and 16, the pallet sled 12a retrieves two empty pallets 50 from a pallet destacker 160 (or “pallet dispenser”). The pallet destacker 160 includes a column 170 for retaining a plurality of pallets 50. In this example, the pallets 50 are retained in two columns. When prompted, the pallet destacker 160, releases or dispenses two pallets 50 from the bottom of the stacks onto the floor or directly onto the tines 16a of the pallet sled 12a. When the pallet sled 12a retrieves the pallets 50, it reads the rfid tags 56 on those pallets 50 (the mobile device 24a reads the rfid tags 56 or an external accessory rfid reader reads the rfid tags 56). The mobile device 24a determines a pallet id of each pallet 50 based upon the rfid tags 56. The pick lists 38 that are about to be picked are then assigned to those pallets 50.

Alternatively, the pallet destacker 160 may include at least one processor 172 (together with electronic storage of data and instructions for causing the at least one processor 172 to perform the functions described herein). The pallet destacker 160 may also include a communication circuit 174, such as wifi, Bluetooth, NFC, etc. for communicating with the mobile device 24a of the pallet sled 12a directly or via the remote CPU 30. The pallet destacker 160 also includes a rfid reader 166 mounted on or near the pallet destacker 160 and connected to the at least one processor 172. In this example, the rfid tags 56 on the pallets 50 and an rfid tag 168 on the pallet sled 12a can be read by the rfid reader 166, which determines the pallet ids based upon the rfid tags 56 and associates the pallet ids with the pallet sled 12a and communicates the pallet ids to the mobile device 24a and/or the remote CPU 30.

Either way, the mobile device 24a knows which pallets 50 are on the pallet sled 12a and associates them with the pick lists 38. At the same time, the mobile device 24a receives the pallet configuration 40 for each of the pallets 50 on the pallet sled 24a.

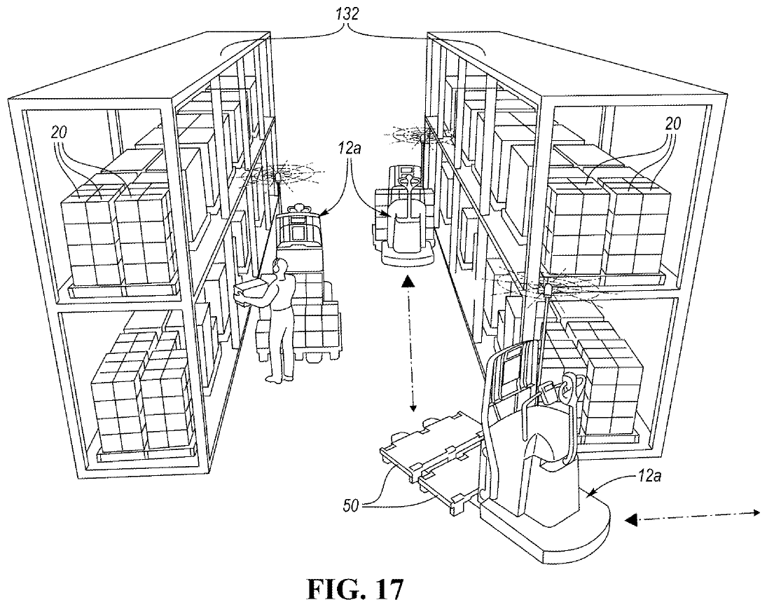

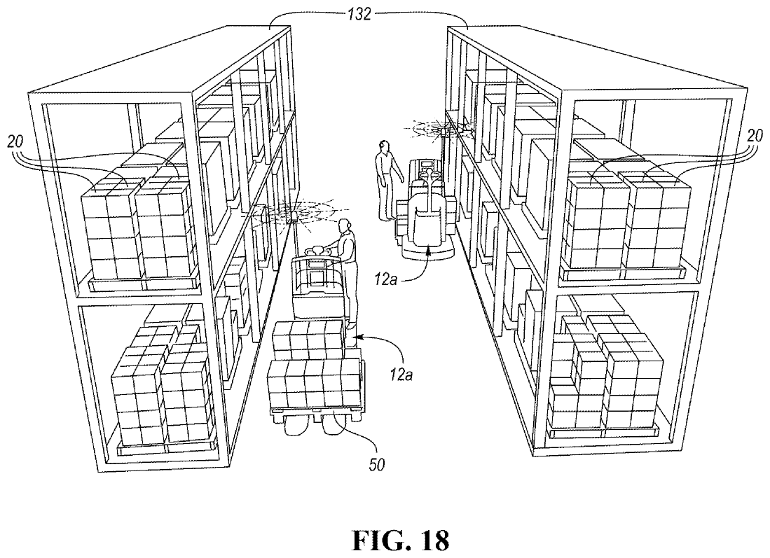

FIGS. 17 and 18 illustrate a particular method that can be used with the automated guided vehicle pallet sleds 12a. Referring to FIG. 17, for high-volume products 20, a picker can be stationed in the aisle near the high-volume products 20 and load each pallet sled 12a when it comes to the picker. As before, the picker would still view the mobile device 24a front facing screen to confirm the product 20 and to learn the quantity and where on the pallets 50 to place the product(s) 20.

In low volume zones as shown in FIG. 18, a picker would travel with (on) each pallet sled 12a to pick the products 20 for the pallets 50 on the pallet sled 12a as described above.

If both high-volume and low-volume zones are necessary to load the pallets 50 on the pallet sled 12a, the pallet sled 12a preferably obtains the high-volume products 20 first as described above with respect to FIG. 17 (without a picker riding or traveling with it), and then the pallet sled 12a picks up a picker who then travels with it to the low-volume zones to load the low-volume products 20.

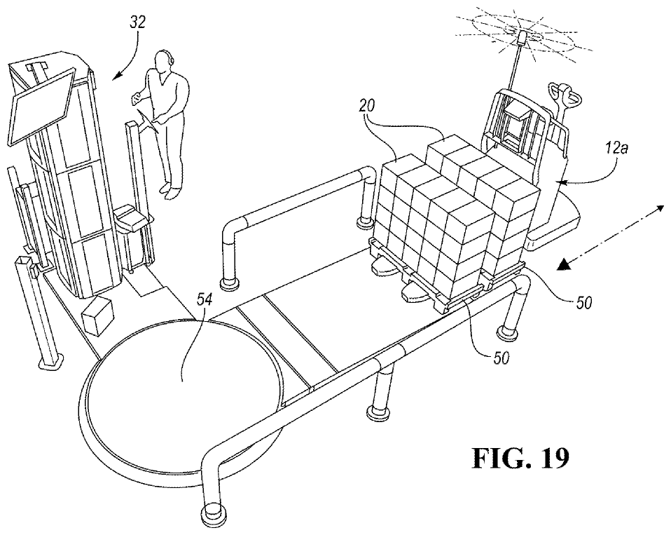

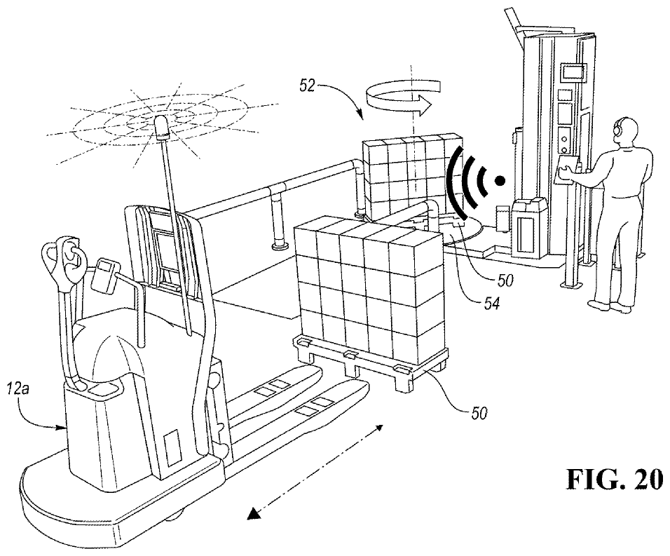

In FIG. 19, after the pallets 50 are loaded in any of the ways described above, the pallet sled 12a drops the loaded pallets 50 at the validation station 52. As shown in FIG. 20, the pallet sled 12a may leave one loaded pallet 50 on a turntable 54 for validation, while placing the other loaded pallet 50 nearby. The pallet sled 12a may then go to retrieve two more empty pallets from the destacker 160 (FIGS. 15 and 16).

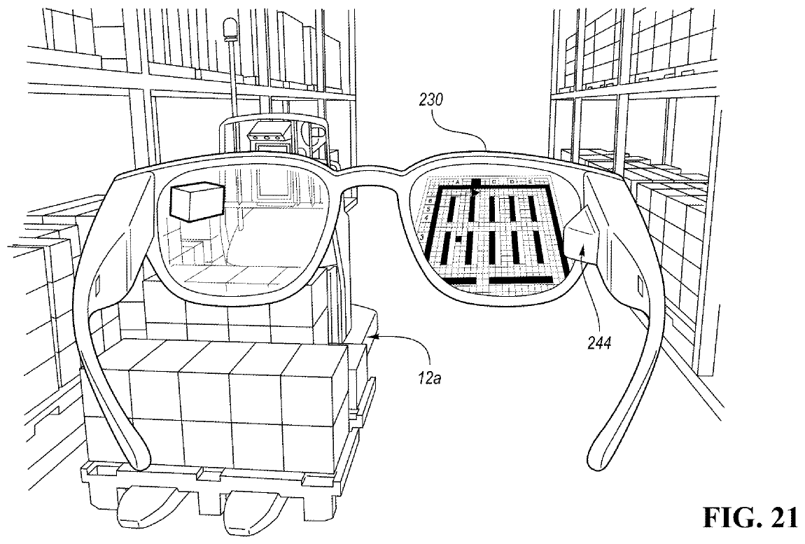

FIG. 21 illustrates a variation of the pick stations disclosed above in which smart glasses 230 are used as the mobile device instead of (or in addition to) a tablet/smart phone form factor. As shown in FIG. 21, the smart glasses 230 have a camera 244 and can display an indication of the next product to retrieve and a map to the next product but the automated guided vehicle pallet sled 12a already can drive itself to the right locations.

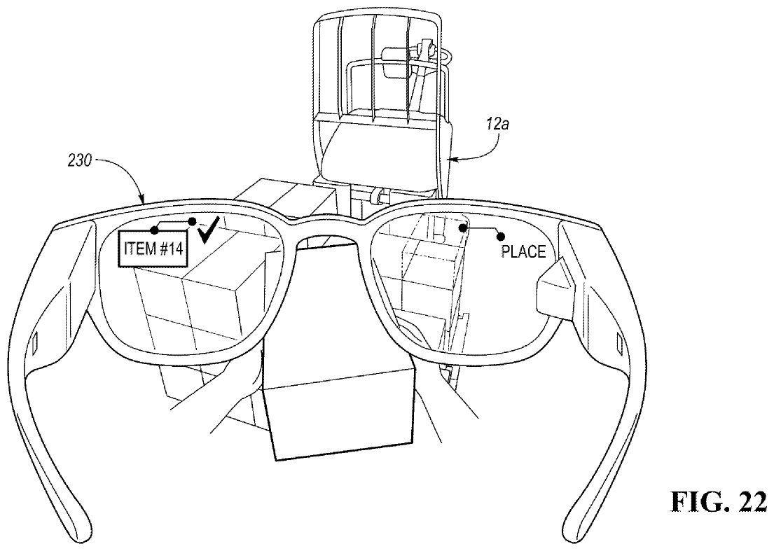

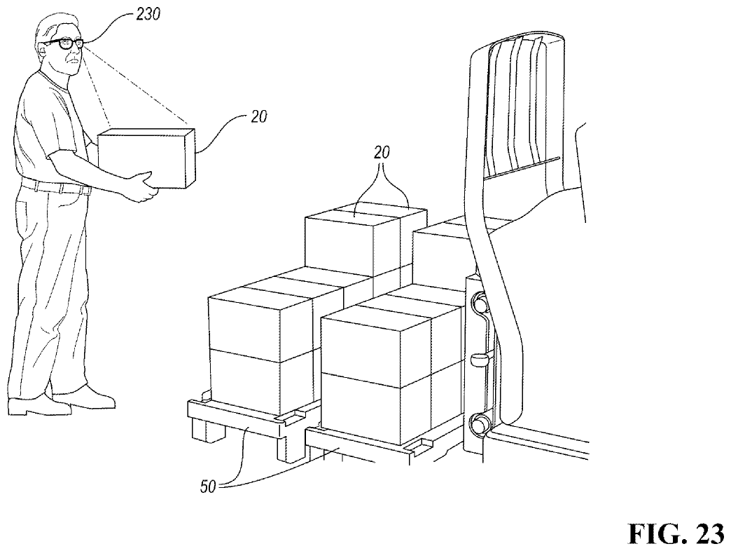

As shown in FIG. 22, the glasses 230 will naturally have a good field of view of each product 20 carried by the user so that the glasses 230 (possibly in conjunction with the mobile device 24a) can display a confirmation (or rejection) that the correct product has been selected. Using augmented reality, the glasses 230 can overlay an indication of where to place the next product onto the user's real, live view of the products 20 stacked on the pallet sled 12a. The smart glasses 230 also verify the location of the product 20 placed on the pallets 50 based upon image(s) from the camera 244. FIG. 23 is another view of the user wearing the glasses 230 and placing the next product 20 onto the pallets 50.

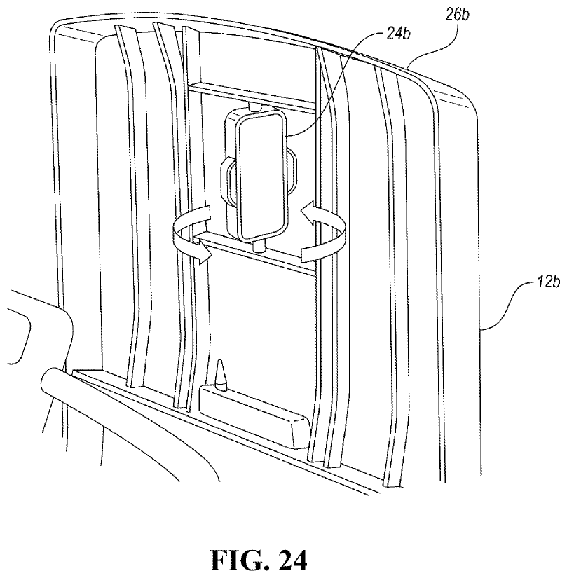

FIG. 24 is a portion of an alternate pallet sled 12b with a frame 26b extending upward from a base 14b. A mobile device 24b is the same as the mobile device 24 of FIGS. 1-23 except it only has one touchscreeen. As shown, the mobile device 24b is rotatably mounted to the frame 26b, such that the display of the mobile device 24b can be directed forward of or rearward of the pallet sled 12b. In the example shown, the mobile device 24b is mounted rotatably about a vertical axis, but the mobile device 24b could be mounted to rotate about a horizontal axis or any axis.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A pallet sled comprising:
a base;
a pair of tines extending from the base;
a display; and
at least one processor programmed to provide a series of instructions on the display indicating a plurality of products to be placed on at least one pallet supported by the tines.

2. The pallet sled of claim 1 wherein the at least one processor is programmed to cause the display to display a color image of each of the plurality of products to be placed on the at least one pallet.

3. The pallet sled of claim 1 wherein the at least one processor is programmed to cause the display to display a map indicating a location of a next product to be retrieved and a quantity of the next product to be retrieved.

4. The pallet sled of claim 1 further including a camera configured to image a product being retrieved by a user, wherein the at least one processor is programmed to analyze the image to determine if the product being retrieved by the user is a next product to be retrieved.

5. The pallet sled of claim 4 wherein the at least one processor is programmed to cause the display to display a rejection screen based upon the at least one processor determining that the product being retrieved by the user is not the next product to be retrieved.

6. The pallet sled of claim 1 wherein the at least one processor is programmed to cause the display to display a desired location to place a next product of the plurality of products relative to the at least one pallet supported by the tines.

7. The pallet sled of claim 6 wherein the at least one processor is programmed to generate a 3D image of the at least one pallet supported by the tines and a plurality of products already placed on the at least one pallet and to include in the 3D image an indication of where the next product should be placed, and wherein the at least one processor is programmed to cause the display to display the 3D image.

8. The pallet sled of claim 6 further including a camera configured to image the plurality of products on the at least one pallet supported by the tines, and wherein the at least one processor is programmed to analyze the image to determine whether at least one of the plurality of products is in a correct location.

9. The pallet sled of claim 8 wherein the at least one processor is programmed to cause the display to display a rejection based upon the at least one processor determining that at least one of the plurality of products is in an incorrection location.

10. The pallet sled of claim 1 wherein the pallet sled is an automated guided vehicle.

11. The pallet sled of claim 1 wherein the display and at least one processor are components of a tablet or smartphone.

12. The pallet sled of claim 11 wherein the tablet or smartphone is rotatably mounted relative to the base such that the display can selectively face forward or rearward of the pallet sled.

13. The pallet sled of claim 1 wherein the at least one processor is programmed to associate an rfid tag of each of the at least one pallet with each of at least one pick sheet containing a list of SKUs associated with an order.

14. The pallet sled of claim 13 further including an rfid reader configured to read the rfid tag on each of the at least one pallet supported by the tines.

15. A pallet sled comprising:
a base;
a pair of tines extending from the base; and
a display rotatably mounted relative to the base so that the display can selectively face forward or rearward of the pallet sled.

16. A pallet destacker comprising:
a column for retaining at least one stack of pallets;
an rfid reader configured to read rfid tags on the pallets;
a processor programmed to determine pallet ids based upon the rfid tags; and
a communication circuit for transmitting the pallet ids.

17. A method for picking a pallet including the steps of:
a) displaying on a display a pallet sled a next product image of a next product to be retrieved; and
b) displaying on the display a location on the pallet sled where to place the next product to be retrieved.

18. The method of claim 17 wherein said step b) further includes displaying the location relative to at least one pallet.

19. The method of claim 17 wherein said step b) further includes displaying the location relative to two pallets on the pallet sled.

20. The method of claim 17 further including the steps of:
c) imaging a product as it is being brought toward the pallet sled;
d) analyzing the image of the product to determine if it is the next product to be retrieved; and
e) indicating whether the product is the next product to be retrieved.

21. The method of claim 20 further including the step of transmitting a result of step d) to a validation station.
